(19) United States
(12) Patent Application Publication
(10) Pub. No.: US 2026/0070340 A1
(43) Pub. Date: Mar. 12, 2026

(54) Maintenance Method and Care Method of Print Head, Printer, and Printing Apparatus

(71) Applicant: Shenzhen Anker Smart Technology Co., Ltd, Shenzhen (CN)

(72) Inventors: Haoxuan Wang, Shenzhen (CN); Hanlong Fu, Shenzhen (CN)

(21) Appl. No.: 19/250,851

(22) Filed: Jun. 26, 2025

(30) Foreign Application Priority Data
Jun. 26, 2024 (CN) 202410840440.1

(51) Int. Cl. B41J 2/165; B41J 2/045

(52) U.S. Cl. CPC B41J 2/16532; B41J 2/04513; B41J 2/16552; B41J 2/04581; B41J 2002/16573; B41J 2002/16597

(57) ABSTRACT

Disclosed are a maintenance method and a care method of a print head, a printer, and a printing apparatus. After printing completion, cleaning liquid may be controlled to be poured into a print head to clean the print head. After cleaning completion, less corrosive moisturizing liquid may be poured into the print head to keep the print head moist, which can reduce concern of blockage of the print head. This approach may reduce retention time of the ink in the print head. The less corrosive moisturizing liquid may be used to keep the print head moist and/or reduce possibility of the print head being corroded. Such approaches may maintain an operational performance of the print head.

### CROSS-REFERENCE TO RELATED APPLICATION

The present application claims priority to Chinese Patent Application No. 202410840440.1, filed on Jun. 26, 2024, which is herein incorporated by reference by its entirety.

### FIELD

The present disclosure relates to the technical field of printers, including a maintenance method and a care method of a print head, a printer, and a printing apparatus.

### BACKGROUND

A printer may refer to a device that accurately jets ink or other printing media onto paper or other media according to received signals so as to form numbers, letters, symbols, graphics, and/or other contents that people can recognize. The printer may be used in work, home and business scenes, with various applications.

However, because the ink used by the printer may be corrosive and the print head of the printer may be in contact with this type of ink for a long time, this may damage a plastic film, seal glue, and/or other parts inside the print head, and/or may also corrode circuits, causing ink mixing and ink leakage of the print head, which may result in printing failure and other problems. In addition, particles in the ink may also accumulate or precipitate at the print head, blocking the print head and affecting coloring of the print head. Therefore, the reliability of conventional printers may be low.

### SUMMARY

Aspects described herein relate to a maintenance method and device of a print head, a printing apparatus, a computer-readable storage medium, and/or a computer program product which can improve operation reliability of the printer, particularly in view of the low reliability of conventional printers.

Aspects described herein relate to a maintenance method of a print head, comprising: receiving a printing completion signal; controlling a cleaning liquid to be poured into the print head in response to the printing completion signal, the cleaning liquid being configured to clean the print head; receiving a cleaning completion signal; and/or controlling a moisturizing liquid to be poured into the print head in response to the cleaning completion signal, wherein the moisturizing liquid may be configured to keep the print head moist, corrosiveness of the moisturizing liquid may be less than corrosiveness of the cleaning liquid, and/or wherein the cleaning completion signal may be configured to indicate completion of a cleaning process of the print head.

Aspects described herein also relate to a care method of a print head, comprising: receiving a printing completion signal; receiving a cleaning liquid in response to the printing completion signal, the cleaning liquid being configured to clean the print head; receiving a cleaning completion signal; and/or receiving the moisturizing liquid in response to the cleaning completion signal, wherein the moisturizing liquid may be configured to keep the print head moist, wherein the corrosiveness of the moisturizing liquid may be less than corrosiveness of the cleaning liquid, and/or wherein the cleaning completion signal may be configured to indicate completion of a cleaning process of the print head.

Aspects described herein also relate to a printing apparatus comprising a printer, a memory, and/or a processor, wherein the printer includes a print head, wherein the memory stores a computer program, and wherein the processor implements one or more of the following steps when executing the computer program: receiving a printing completion signal; controlling a cleaning liquid to be poured into the print head in response to the printing completion signal, the cleaning liquid being configured to clean the print head; receiving a cleaning completion signal; and/or controlling a moisturizing liquid to be poured into the print head in response to the cleaning completion signal, wherein the moisturizing liquid may be configured to keep the print head moist, corrosiveness of the moisturizing liquid may be less than corrosiveness of the cleaning liquid, and/or wherein the cleaning completion signal may be configured to indicate completion of a cleaning process of the print head.

Aspects described herein also relate to a printer including a print head configured to perform one or more of the following steps: receiving a printing completion signal; receiving a cleaning liquid in response to the printing completion signal, the cleaning liquid being configured to clean the print head; receiving a cleaning completion signal; and/or receiving the moisturizing liquid in response to the cleaning completion signal, wherein the moisturizing liquid may be configured to keep the print head moist, wherein the corrosiveness of the moisturizing liquid may be less than corrosiveness of the cleaning liquid, and wherein the cleaning completion signal may be configured to indicate completion of a cleaning process of the print head.

For the maintenance method and the care method of the print head, the printer, and the printing apparatus, after the printing completion signal may be received, the cleaning liquid may be controlled to be poured into the print head to clean the print head, and after the cleaning may be finished, the less corrosive moisturizing liquid may be controlled to be poured into the print head to keep the print head moist, which can reduce concern of blockage of the print head. In addition, this method may also reduce retention time of the ink in the print head, and make the print head in the less corrosive moisturizing liquid after printing may be finished and cleaning may be completed, which can not only keep the print head moist, but also reduce possibility of the print head being corroded, which may be conducive to ensuring operation performance of the print head, thereby improving operation reliability of the printer.

### BRIEF DESCRIPTION OF THE DRAWINGS

Drawings illustrating various aspects of the disclosure are summarized below. These drawings are merely some examples of the present disclosure.

FIG. 1 is an illustrative flowchart of a maintenance method of a print head;

FIG. 2 is an illustrative flowchart of a maintenance method of a print head;

FIG. 3 is an illustrative flowchart of a maintenance method of a print head;

FIG. 4 is an illustrative flowchart of a maintenance method of a print head;

FIG. 5 is an illustrative flowchart of a maintenance method of a print head;

FIG. 6 is an illustrative flowchart of a maintenance method of a print head;

FIG. 7 is an illustrative flowchart of a maintenance method of a print head;

FIG. 8 is an illustrative flowchart of a care method of a print head;

FIG. 9 is an illustrative flowchart of a maintenance method of a print head;

FIG. 10 is an illustrative operation flowchart of a printer with a continuous ink supply path;

FIG. 11 is an illustrative operation flowchart of a printer with a direct-insertion ink path; and

FIG. 12 is an illustrative structure block diagram of a maintenance device of a print head.

### DETAILED DESCRIPTION

Further detailed description of the present disclosure may be made with reference to the accompanying drawings and examples below. It may be understood that the specific examples described herein merely provide examples of the present disclosure and do not limit the present disclosure.

A maintenance method of a print head provided by the example of the disclosure may be used for maintaining the print head. An environment where the print head may be located may be controlled by the maintenance method of the print head proposed in this disclosure. The print head may be a key component in a printer, which may be responsible for accurately jetting ink or other printing media onto paper or other media to form characters and images. The print head may be used in an ink-jet printer. The print head may contain a series of tiny nozzles, which can jet ink droplets onto the paper or other media through different technologies (such as thermal ink-jet technology or piezoelectric technology).

Illustratively, the maintenance method of the print head may maintain a print head using UV ink. The UV ink may be a special type of ink, which quickly solidifies into a film under ultraviolet irradiation. This ink may be usually applied in fast printing and drying applications, such as commercial printing and packaging industries. Main components of the UV ink include photoinitiator, prepolymer, monomer, and pigment. Because the monomer in the UV ink may be corrosive, long-term contact with the UV ink may damage a plastic film, seal glue and other parts inside a piezoelectric print head, which may result in problems such as ink mixing, ink leakage, corrosion of circuits, and/or failure of printing lanes. In addition, in order to achieve coloring effect, the UV ink may be added with color particles, and these color particles may accumulate or precipitate in the print head, thus blocking small holes of the print head, and causing inaccurate coloring of the print head, or might in some more serious cases prevent the print head from coloring at all. In order to solve these problems, aspects described herein relate to a maintenance method and a care method of a print head, a printer, and/or a printing apparatus, which can reduce corrosion of the UV ink to the printer and reduce blockage of the printer.

The maintenance method of the print head may be executed by a controller inside the printer, by a terminal, and/or by a server connected with the printer in communication. The terminal may be but is not limited to various personal computers, notebook computers, smart phones, tablet computers, Internet of Things devices, and/or portable wearable devices. The server may be an independent physical server, a server cluster or distributed system composed of multiple physical servers, and/or a cloud server providing cloud computing services.

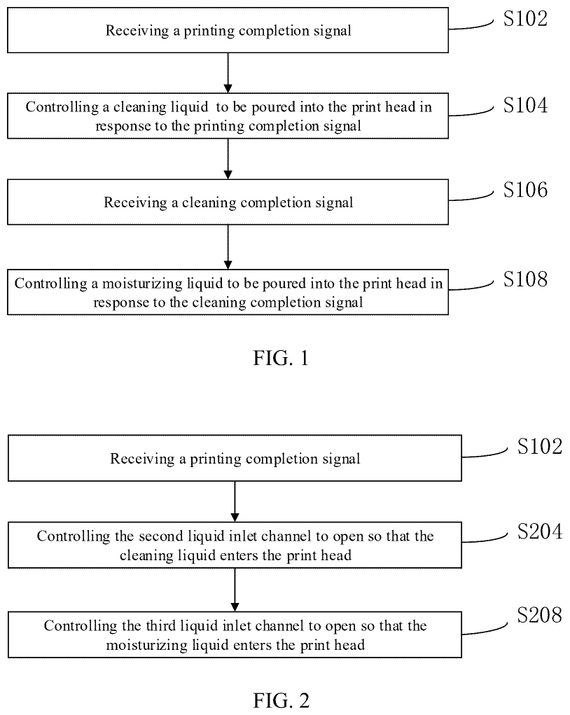

As shown in FIG. 1, a maintenance method of a print head may be provided, which may be illustrated by taking the method executed by the controller as an example, and may include following steps 102 to 108.

In Step 102, a printing completion signal may be received.

The printing completion signal may be configured to indicate that the printer has completed a printing operation this time. After printing-related elements in the printer complete the printing operation, the printing completion signal may be sent to the controller, and the controller receives the printing completion signal. Additionally and/or alternatively, the controller might control the printing-related elements in the printer to complete the printing operation according to a preset printing flow, after which it might be considered that the printing completion signal may be received. The printing completion signal may be a signal after a single printing may be finished each time. If the printer has multiple printing tasks in a certain period of time, the printing completion signal may be generated after each of the printing tasks may be finished. The printing completion signal may also be a signal after last single printing in a certain period of time may be finished. If the printer has multiple printing tasks in a certain period of time, the printing completion signal may be generated after a last printing task may be finished.

The printing completion signal may indicate that the printer no longer needs ink at this time. In addition, after each time of printing may be completed, the step of this method may be executed.

In Step 104, in response to the printing completion signal, a cleaning liquid may be controlled to be poured into the print head.

The cleaning liquid may be configured to clean the print head. The cleaning liquid may be a type of chemical solution specially used to clean the print head. A main function of such a cleaning liquid may be to dissolve dry ink in the print head, remove blockage and restore a normal operation state of the print head. A specific type of the cleaning liquid may be not limited herein.

The controller can control the print head to be connected with a container filled with the cleaning liquid, and may control a passage between the print head and the cleaning liquid to open so that the cleaning liquid enters the print head, so as to control the cleaning liquid to be poured into the print head. After entering the print head, the cleaning liquid may begin to dissolve the dry ink in the print head and may remove the blockage in the print head, which may cause cleaning of the print head.

In Step 106, a cleaning completion signal may be received.

The cleaning completion signal may be configured to indicate completion of a cleaning process of the print head. After the cleaning liquid may be poured into the print head and the print head may be cleaned, the controller may receive the cleaning completion signal.

In Step 108, in response to the cleaning completion signal, a moisturizing liquid may be controlled to be poured into the print head.

The moisturizing liquid may be configured to keep the print head moist, so as to prevent the ink from drying up and an orifice of the print head from being blocked. Corrosiveness of the moisturizing liquid may be less than corrosiveness of the cleaning liquid. The moisturizing liquid may be non-corrosive and/or less corrosive than the cleaning liquid.

After controlling the cleaning liquid to be poured into the print head to complete cleaning of the print head, the controller may receive the cleaning completion signal, and then may control the moisturizing liquid to be poured into the print head, so that the print head may be in the less corrosive moisturizing liquid, thereby reducing a probability of the print head being corroded. The moisturizing liquid may also moisturize the print head and/or prevent the ink from drying up and the orifice of the print head from being blocked, which may be conducive to ensuring operation performance of the print head so that printing quality may be ensured when the print head may be used for printing next time. The print head may be kept in the moisturizing liquid for a long time, and the moisturizing liquid might have little influence on the print head.

To mitigate failure problems such as corrosion and blockage of the print head caused in printing with the ink, a maintenance method of the print head may reduce a residence time of the ink in the print head. The cleaning liquid may be poured into the print head to clean the print head after each time of printing, and then the moisturizing liquid may be poured into the print head and replace the cleaning liquid with strong corrosiveness, so that the printer may be cleaned and moisturized after each time of printing. This means that the probability that the print head may be corroded may be reduced by increasing the frequency of cleaning, and there may be almost no ink in the print head when the printer is not in operation. The concern of blockage of the print head may be reduced by the cleaning liquid and the moisturizing liquid, and the risk of corrasion of the print head may be reduced by the moisturizing liquid. Therefore, it may be conducive to ensure the operation performance of the print head, thus improving operation reliability of the printer.

The print head may be provided with a plurality of liquid inlet channels. There may be any number (e.g., three, four, and/or five) liquid inlet channels. For example, a plurality of liquid inlet channels of the print head may include a first liquid inlet channel for receiving the ink, a second liquid inlet channel for receiving the cleaning liquid, and/or a third liquid inlet channel for receiving the moisturizing liquid. As shown in FIG. 2, the step 104 may include a step 204 in which the second liquid inlet channel may be controlled to open so that the cleaning liquid enters the print head.

The printer may have a continuous ink supply path provided with an ink cartridge for storing the ink, a cleaning liquid cartridge for storing the cleaning liquid, and/or a moisturizing liquid cartridge for storing the moisturizing liquid. The liquid inlet channels of the print head include a first liquid inlet channel for receiving the ink, a second liquid inlet channel for receiving the cleaning liquid, and/or a third liquid inlet channel for receiving the moisturizing liquid. An end of the first liquid inlet channel away from the print head may be connected with the ink cartridge and may communicate with the inside of the ink cartridge and may be configured to receive the ink. An end of the second liquid inlet channel away from the print head may be connected with the cleaning liquid cartridge and may communicate with the inside of the cleaning liquid cartridge and may be configured to receive the cleaning liquid. An end of the third liquid inlet channel away from the print head may be connected with the moisturizing liquid cartridge and may communicate with the inside of the moisturizing liquid cartridge and may be configured to receive the moisturizing liquid. The print head may receive the ink through the first liquid inlet channel, the cleaning liquid through the second liquid inlet channel, and/or the moisturizing liquid through the third liquid inlet channel. The controller may control the second liquid inlet channel to open, so that the cleaning liquid inside the cleaning liquid cartridge can enter the print head through the opening second liquid inlet channel.

The printer may comprise channel switches. The channel switches may be arranged between the first liquid inlet channel, the second liquid inlet channel, and the third liquid inlet channel and the print head and may be configured to control open states of the first liquid inlet channel, the second liquid inlet channel, and/or the third liquid inlet channel. That is, the channel switch may control the first liquid inlet channel to open, and both the second liquid inlet channel and the third liquid inlet channel to close, so that the print head receives the ink through the first liquid inlet channel. Additionally and/or alternatively, the channel switch may control the second liquid inlet channel to open, and both the first liquid inlet channel and the third liquid inlet channel to close, so that the print head receives the cleaning liquid through the second liquid inlet channel. Additionally and/or alternatively, the channel switch may control the third liquid inlet channel to open, and both the first liquid inlet channel and the second liquid inlet channel to close, so that the print head receives the moisturizing liquid through the third liquid inlet channel.

An operation state of the channel switch may be controlled by the controller. The controller may control the second liquid inlet channel to open through the channel switch, so that the cleaning liquid in the cleaning liquid cartridge enters the print head through the opening second liquid inlet channel, and thus the cleaning liquid may be poured into the print head. The channel switch(es) may comprise, for example, a solenoid valve, and/or other valves. Pumps may be provided in the first liquid inlet channel, the second liquid inlet channel, and/or the third liquid inlet channel, and when liquid may be needed, the controller may control the pumps to start operation to help the liquid flow.

The print head may be provided with a plurality of liquid inlet channels, and the liquid inlet channels of the print head might include a first liquid inlet channel for receiving the ink, a second liquid inlet channel for receiving the cleaning liquid, and/or a third liquid inlet channel for receiving the moisturizing liquid. The cleaning liquid may enter the print head by controlling the second liquid inlet channel to open, so that the cleaning liquid may be poured into the print head to realize cleaning of the print head.

Based on the structure in which the print head may be provided with a plurality of liquid inlet channels, and the liquid inlet channels of the print head may include a first liquid inlet channel for receiving the ink, a second liquid inlet channel for receiving the cleaning liquid, and/or a third liquid inlet channel for receiving the moisturizing liquid, as shown in FIG. 2, the step 108 may include step 208 in which the third liquid inlet channel may be controlled to open so that the moisturizing liquid enters the print head.

The printer may also be a printer with a continuous ink supply path. The controller may control the third liquid inlet channel to open, so that the moisturizing liquid in the moisturize liquid cartridge might enter the print head through the opening third liquid inlet channel.

When the printer further includes a channel switch, an operation state of the channel switch may be controlled by the controller. The controller may control the channel switch to open the third liquid inlet channel, so that the moisturizing liquid in the moisturizing liquid cartridge may enter the print head through the opened third liquid inlet channel, and thus the moisturizing liquid may be poured into the print head. The channel switch may comprise, for example, a solenoid valve and/or other valves. Pumps may be provided in the first liquid inlet channel, the second liquid inlet channel, and/or the third liquid inlet channel, and when liquid may be needed, the controller may control the pumps to start operation to help the liquid flow.

The liquid inlet channels of the print head may include a first liquid inlet channel for receiving the ink, a second liquid inlet channel for receiving the cleaning liquid, and/or a third liquid inlet channel for receiving the moisturizing liquid. By controlling the third liquid inlet channel to open so that the moisturizing liquid enters the print head, the moisturizing liquid may be poured into the print head, which may facilitate cleaning of the print head to improve printing quality, and may reduce corrosion of the print head to prolong service life of the print head.

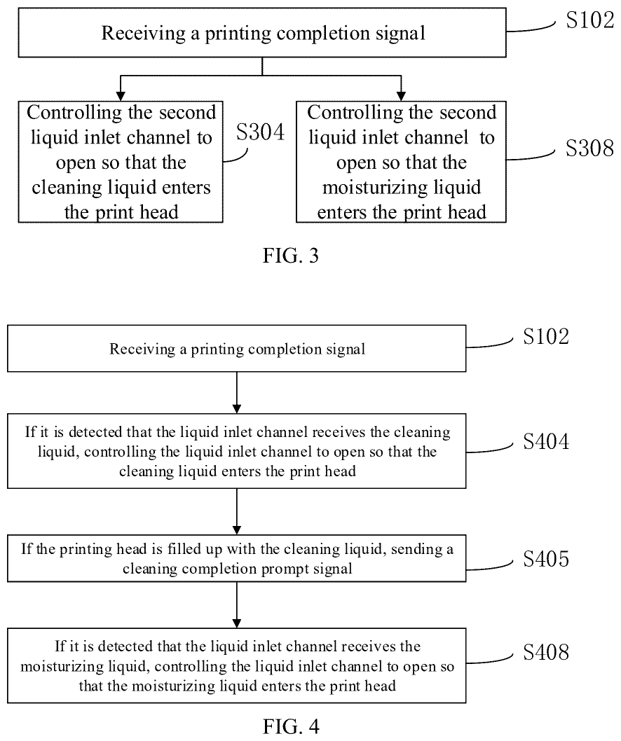

The print head may be provided with two liquid inlet channels, and the liquid inlet channels of the print head may include a first liquid inlet channel for receiving the ink and/or a second liquid inlet channel for receiving the cleaning liquid or the moisturizing liquid. As shown in FIG. 3, the step 104 may include step 304, and the step 108 may include step 308.

In step 304, the second liquid inlet channel may be controlled to open so that the cleaning liquid enters the print head.

In step 308, the second liquid inlet channel may be controlled to open so that the moisturizing liquid enters the print head.

The printer may be a printer with a continuous ink supply path provided with an ink cartridge for storing the ink, a cleaning liquid cartridge for storing the cleaning liquid, and/or a moisturizing liquid cartridge for storing the moisturizing liquid. The liquid inlet channels of the print head may include a first liquid inlet channel for receiving the ink, a second liquid inlet channel for receiving the cleaning liquid, and/or a third liquid inlet channel for receiving the moisturizing liquid. An end of the first liquid inlet channel away from the print head may be connected with the ink cartridge and communicates with the inside of the ink cartridge and may be configured to receive the ink. An end of the second liquid inlet channel away from the print head may be connected with the cleaning liquid cartridge and communicates with the inside of the cleaning liquid cartridge and may be configured to receive the cleaning liquid. An end of the third liquid inlet channel away from the print head may be connected with the moisturizing liquid cartridge and may communicate with the inside of the moisturizing liquid cartridge and may be configured to receive the moisturizing liquid. The print head may receive the ink through the first liquid inlet channel, the cleaning liquid through the second liquid inlet channel, and/or the moisturizing liquid through the third liquid inlet channel. The controller may control the second liquid inlet channel to open, so that the cleaning liquid inside the cleaning liquid cartridge may enter the print head through the opening second liquid inlet channel. In some circumstances, only one type of liquid might be configured to enter the second liquid inlet channel at the same time, which may be (for example) the cleaning liquid or the moisturizing liquid. For example, after printing may be completed, the second liquid inlet channel may receive the cleaning liquid first, and then may receive the moisturizing liquid after cleaning.

The printer may also comprise channel switches. The channel switches may be configured to control open states of the first liquid inlet channel and the second liquid inlet channel. That is, the channel switch may control the first liquid inlet channel to open and the second liquid inlet channel to close, so that the print head receives the ink through the first liquid inlet channel. Additionally and/or alternatively, the channel switch may control the second liquid inlet channel to open and the first liquid inlet channel to close, so that the print head receives the cleaning liquid or the moisturizing liquid through the second liquid inlet channel.

An operation state of the channel switch may be controlled by the controller. The controller may control the second liquid inlet channel to open through the channel switch, so that the cleaning liquid in the cleaning liquid cartridge enters the print head through the opening second liquid inlet channel, and thus the cleaning liquid may be poured into the print head. After cleaning may be completed, the moisturizing liquid in the moisturizing liquid cartridge may enter the print head through the opened second liquid inlet channel, so that the moisturizing liquid may be poured into the print head. The type of channel switch need not be limited, for example, it may be a solenoid valve and/or other valves. Pumps may be provided in the first liquid inlet channel and/or the second liquid inlet channel, and when liquid may be needed, the controller may control the pumps to start operation to help the liquid flow.

The print head may be provided with a plurality of liquid inlet channels, and the liquid inlet channels of the print head may include a first liquid inlet channel for receiving the ink, a second liquid inlet channel for receiving the cleaning liquid, and/or a third liquid inlet channel for receiving the moisturizing liquid. By controlling the second liquid inlet channel to open so that the cleaning liquid or the moisturizing liquid enters the print head, the cleaning liquid may be poured into the print head, which may realize cleaning of the print head, and the moisturizing liquid may be poured into the print head, which may realize maintenance of the print head.

The print head may be provided with one liquid inlet channel configured to receive the ink, the cleaning liquid, and/or the moisturizing liquid. As shown in FIG. 4, the step 104 may include step 404, and the step 108 may include step 408.

In step 404, if it may be detected that the liquid inlet channel receives the cleaning liquid, the liquid inlet channel may be controlled to open so that the cleaning liquid enters the print head.

The printer may be a printer with a direct-insertion ink path, and the printer with the direct-insertion ink path may be added with the ink cartridge, the cleaning liquid cartridge, and/or the moisturizing liquid cartridge. A position of the printer with the direct-insertion ink path where the ink cartridge, the cleaning liquid cartridge and/or the moisturizing liquid cartridge may be added communicates with the liquid inlet channel of the print head. When the printing may be needed, a user might install the ink cartridge on the printer, and the ink in the ink cartridge may enter the print head for printing through the liquid inlet channel of the print head. When cleaning may be needed, the user might remove the ink cartridge or other cartridges on the printer and install the cleaning liquid cartridge, and the cleaning liquid may enter the print head through the liquid inlet channel of the print head to clean the print head.

After cleaning, the user might remove the cleaning liquid cartridge on the printer and install the moisturizing liquid cartridge, and the moisturizing liquid may enter the print head through the liquid inlet channel of the print head to moisturize the print head.

The liquid inlet channel may receive the cleaning liquid in a variety of ways. For example, when the controller detects that the printer may be added with the cleaning liquid cartridge, and/or when the controller detects that liquid in the liquid inlet channel may be the cleaning liquid, and/or when the controller receives a signal indicating that the printer may be added with the cleaning liquid cartridge, it may be detected that the liquid inlet channel receives the cleaning liquid.

If the controller detects that the liquid inlet channel receives the cleaning liquid, the liquid inlet channel may be controlled to open so that the cleaning liquid enters the print head. The controller may control a sealing and moisturizing mechanism of the printer to operate so that the cleaning liquid enters the print head. The sealing and moisturizing structure may include a waste ink pad and a vacuum pump. When cleaning may be needed in an operation process of the printer, a cleaning pump may operate to form a negative pressure at a sealing part between the waste ink pad and the print head, so that the ink in the print head may be pumped out, and the print head starts to be washed with the cleaning liquid.

In step 408, if it may be detected that the liquid inlet channel receives the moisturizing liquid, the liquid inlet channel may be controlled to open so that the moisturizing liquid enters the print head. For example, the printer may also be a printer with a direct-insertion ink path.

The controller may detect that the liquid inlet channel receives the moisturizing liquid in a variety of ways. For example, when the controller detects that the printer may be added with the moisturizing liquid cartridge, and/or when the controller detects that liquid in the liquid inlet channel may be the moisturizing liquid, and/or when the controller receives a signal indicating that the printer may be added with the moisturizing liquid cartridge, it may be detected that the liquid inlet channel receives the moisturizing liquid.

If the controller detects that the liquid inlet channel receives the moisturizing liquid, the liquid inlet channel may be controlled to open so that the moisturizing liquid enters the print head. The controller may control a sealing and moisturizing mechanism of the printer to operate so that the moisturizing liquid enters the print head. The sealing and moisturizing structure may include a waste ink pad and/or a vacuum pump. When moisturizing may be needed in an operation process of the printer, a cleaning pump may start to operate to form a negative pressure at a sealing part between the waste ink pad and the print head, so that the ink in the print head may be pumped out, and the print head starts to be washed with the moisturizing liquid.

The liquid inlet channel of the print head may be configured to receive the ink, the moisturizing liquid or the moisturizing liquid. If it may be detected that the liquid inlet channel receives the cleaning liquid, the liquid inlet channel may be controlled to open so that the cleaning liquid enters the print head, and the cleaning liquid may be poured into the print head to realize the cleaning of the print head. If it may be detected that the liquid inlet channel receives the moisturizing liquid, the liquid inlet channel may be controlled to open so that the moisturizing liquid enters the print head, and the moisturizing liquid may be poured into the print head to realize moisturizing of the print head.

As shown in FIG. 4, after the step 404, the maintenance method of the print head further may include a step 405: if the print head may be filled up with the cleaning liquid, a cleaning completion prompt signal may be sent.

The cleaning completion prompt signal may be configured to control a receiving end to send prompt information indicating completion of cleaning.

Determining whether the print head may be filled up with the cleaning liquid may be performed in a variety of ways. For example, the controller can control the cleaning liquid of an amount larger than a volume of the print head to enter the print head, such that the print head might be filled up with the cleaning liquid. Additionally and/or alternatively, a liquid detection device may be installed in the print head, may be connected with the controller and configured to detect a type of liquid in the print head, and when it may be detected that all of liquid in the print head may be the cleaning liquid, a prompt signal may be sent to the controller such that the controller can determine that the print head may be filled up with the cleaning liquid. The print head being filled up with the cleaning liquid may refer to all of liquid in the print head being the cleaning liquid without ink, and/or a concentration of the ink in the cleaning liquid in the print head being lower than a set concentration threshold.

After the cleaning liquid enters the print head, if the print head may be filled up with the cleaning liquid, such a circumstance may indicate that the cleaning process may be completed, and the cleaning completion prompt signal may be sent. After the cleaning completion prompt signal may be transmitted to the receiving end, the receiving end may be controlled to send the prompt information indicating completion of cleaning. The receiving end may be an information prompting device, and the information prompting device may be a display screen, an indicator light, an/or a voice device. Additionally and/or alternatively, the receiving end may also be a terminal that has established communication connection with the controller.

After the prompt information indicating completion of cleaning may be received, the user might remove the cleaning liquid cartridge and install the moisturizing liquid cartridge instead, so that the moisturizing liquid in the moisturizing liquid cartridge can enter the print head through the liquid inlet channel of the print head.

If the print head may be filled up with the cleaning liquid, the cleaning completion prompt signal may be sent, which can make the user know an operation state of the printer in time, and may also remind the user to replace the cleaning liquid cartridge with the moisturizing liquid cartridge in time, and thus the print head may be inside the moisturizing liquid, which may reduce corrosion.

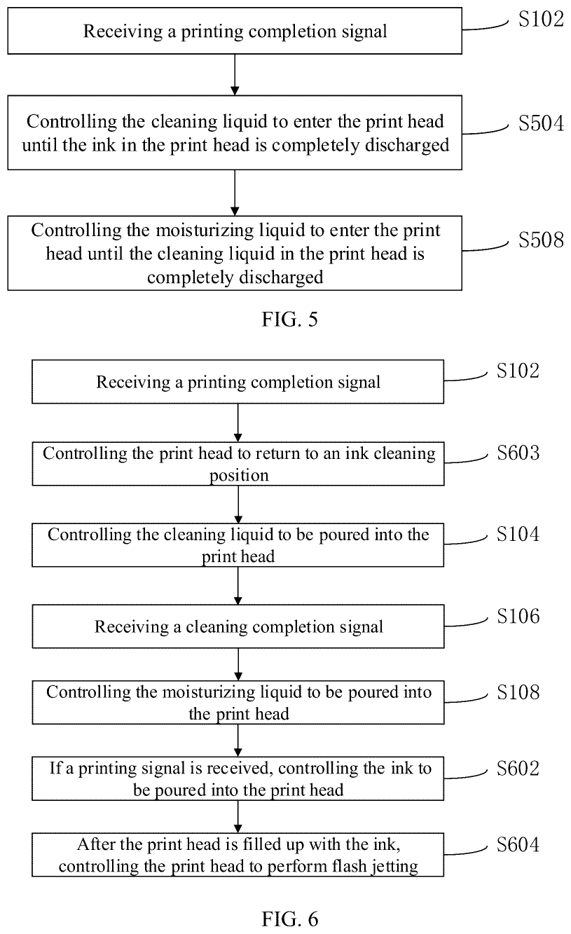

In an example, as shown in FIG. 5, the step 104 may include a step 504 in which the cleaning liquid may be controlled to enter the print head until the ink in the print head may be completely discharged.

When the cleaning liquid may be controlled to enter the print head, the cleaning liquid may be continuously injected until the ink in the print head may be completely discharged, so that the print head may be filled up with the cleaning liquid, so as to improve cleaning effect of the cleaning liquid on the print head and improve cleanliness of the print head.

Determining whether the ink in the print head may be completely discharged may be achieved in a variety of ways. For example, the controller may control the cleaning liquid of an amount larger than a volume of the print head to enter the print head, so as to completely discharge the ink in the print head. Additionally and/or alternatively, a liquid detection device may be installed in the print head, may be connected with the controller and configured to detect a type of liquid in the print head, and when it may be detected that there may be no ink in liquid in the print head or a concentration of the ink may be less than a set concentration threshold, an ink evacuation prompt signal may be sent to the controller, whereby the controller can determine that the ink in the print head may be completely discharged.

The cleaning liquid may be controlled to enter the print head until the ink in the print head may be completely discharged, which might improve cleanliness of the print head and prevent residual ink from corroding the print head.

As shown in FIG. 5, the step 108 may include a step 508 in which the moisturizing liquid may be controlled to enter the print head until the cleaning liquid in the print head may be completely discharged.

When the moisturizing liquid may be controlled to enter the print head, the moisturizing liquid may be continuously injected until the ink in the print head may be completely discharged, so that the print head may be filled up with the moisturizing liquid, so as to and prevent residual cleaning liquid from corroding the print head.

Determining whether the cleaning liquid in the print head may be completely discharged might be achieved in a variety of ways. For example, the controller can control the cleaning liquid of an amount larger than a volume of the print head to enter the print head, so as to completely discharge the ink in the print head.

Additionally and/or alternatively, a liquid detection device may be installed in the print head, may be connected with the controller and configured to detect a type of liquid in the print head, and/or when it may be detected that there may be no cleaning liquid in liquid in the print head or a concentration of the ink may be less than a set concentration threshold, an ink evacuation prompt signal may be sent to the controller, whereby the controller can determine that the ink in the print head may be completely discharged.

The moisturizing liquid may be controlled to enter the print head until the cleaning liquid in the print head may be completely discharged, so that the residual cleaning liquid may be prevented from corroding the print head, which facilitates improving operation reliability of the print head.

The step 504 and the step 108 may be performed together, the step 104 and the step 508 may be performed together, and/or the step 504 and the step 508 may be performed together.

As shown in FIG. 6, after the step 108, the maintenance method of the print head further may include a step 602 in which if a printing signal may be received, the ink may be controlled to be poured into the print head.

After the print head may be placed in the moisturizing liquid in the step 108, if the user needs to print with the printer, the controller might receive the printing signal. After receiving the printing signal, the controller may control the ink to be poured into the print head, so that the print head to jet the ink on paper or other media to form characters and images required by the user.

After the cleaning liquid may be controlled to be poured into the print head, if the printing signal may be received, the ink may be controlled to be poured into the print head, so that the print head jets the ink on paper or other media to form characters and images required by the user.

As shown in FIG. 6, after the step 602, the maintenance method of the print head might further include a step 604 in which after the print head may be filled up with the ink, the print head may be controlled to perform flash jetting.

For instance, after the ink may be controlled to be poured into the print head until the print head may be filled up with the ink and, before the print head performs printing, the controller may control the print head to perform flash jetting, which may be performed once or other times as specifically required by the user.

Flash jetting may refer to controlling the print head to continuously jet ink at a fixed frequency in order to keep the print head in a jetting state over a period of time. Some ink (such as the UV ink) may be easy to volatilize and solidify to form particles in a standing and no-jetting state, which might mean that the ink can easily block the print head. In such a circumstance, after the print head may be filled up with the ink, the print head may be controlled to perform flash jetting, which can clean the print head and keep the print head in the jetting state all the time.

After the print head may be filled up with the ink, the print head may be caused to perform flash jetting, which can clean the print head and keep the print head in the jetting state all the time, thereby improving quality of subsequent printing of the print head.

As shown in FIG. 6, after the step 102 and before the step 104, the maintenance method of the print head may further include a step 603 in which the print head may be controlled to return to an ink cleaning position.

The ink cleaning position may be a preset position, which refers to a position where the ink, the cleaning liquid, and/or the moisturizing liquid may be received. After printing may be completed, the controller may receive the printing completion signal, and then controls the print head to return to the ink cleaning position for subsequent cleaning and moisturizing steps.

After the printing may be completed and before the cleaning, the print head may be controlled to return to the ink cleaning position, so that the print head can normally receive the cleaning liquid and be cleaned.

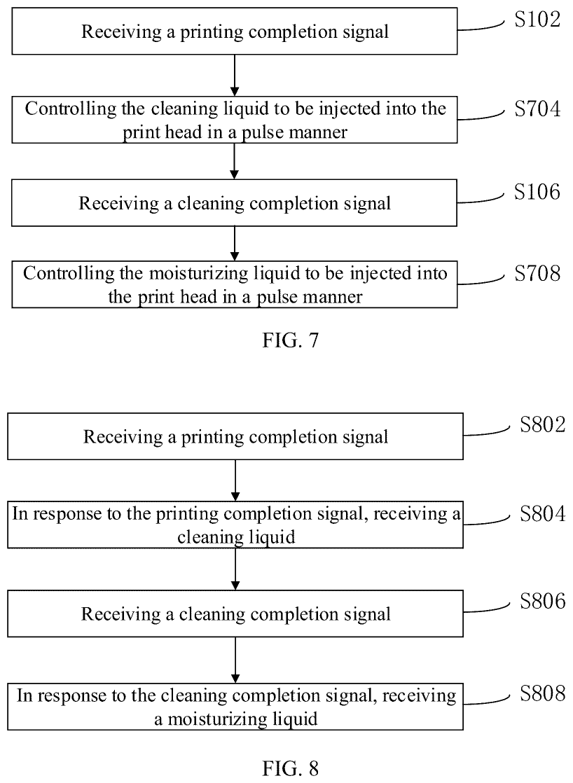

As shown in FIG. 7, the step 104 may include a step 704 in which the cleaning liquid may be controlled to be injected into the print head in a pulse manner.

Controlling the cleaning liquid to be injected into the print head in a pulse manner might refer to the idea that that controlling the cleaning liquid to be injected into the print head at intervals and/or multiple times. A frequency and an amplitude of a pulse may be preset values and are set according to a user's needs, a structure of the printer, and/or the like.

The cleaning liquid may be controlled to be injected into the print head in the pulse manner, which can improve a success rate and efficiency of injecting the cleaning liquid into the print head, and may also improve cleaning effect of the cleaning liquid on the print head

As shown in FIG. 7, the step 108 may include a step 708 in which the moisturizing liquid may be controlled to be injected into the print head in a pulse manner.

Controlling the moisturizing liquid to be injected into the print head in a pulse manner refers that controlling the moisturizing liquid to be injected into the print head at intervals and in multiple times. A frequency and an amplitude of a pulse may be preset values and are set according to a user's needs, a structure of the printer and the like, which are not specifically limited herein.

The moisturizing liquid may be controlled to be injected into the print head in the pulse manner, which may improve a success rate and efficiency of injecting the cleaning liquid into the print head, and may also improve cleaning effect of the cleaning liquid on the print head.

The step 704 and/or the step 108 may be performed together and/or substantially at the same time, the step 104 and the step 708 may be performed together and/or substantially at the same time, and the step 704 and the step 708 may be performed together and/or substantially at the same time.

As shown in FIG. 8, a care method of a print head may be provided, and may include (in addition to and/or as an alternative to any of the steps described herein) steps 802 to 808.

In step 802, a printing completion signal may be received.

The printing completion signal may be configured to indicate that the printer has completed a printing operation this time. After the print head completes the printing operation, it may be considered that the printing completion signal may be received. Additionally and/or alternatively, the controller controls the printing-related elements in the printer to complete the printing operation according to a preset printing flow, after which the printing completion signal may be sent to the print head. The printing completion signal may be a signal after a single printing may be finished each time. If the printer has multiple printing tasks in a certain period of time, the printing completion signal may be generated after each of the printing tasks may be finished. The printing completion signal may also be a signal after last single printing in a certain period of time may be finished. If the printer has multiple printing tasks in a certain period of time, the printing completion signal may be generated after a last printing task may be finished.

The printing completion signal may indicate that the printer no longer needs ink (e.g., at the time the signal is sent/received). After each time of printing may be completed, the step of this method may be executed.

In step 804, in response to the printing completion signal, a cleaning liquid may be received.

The cleaning liquid may be configured to clean the print head. The cleaning liquid may be a type of chemical solution specially used to clean the print head. A main function thereof may be to dissolve dry ink in the print head, remove blockage and restore a normal operation state of the print head. A specific type of the cleaning liquid may be not limited herein, as long as those skilled in the art think it may be implemented.

The controller may control the print head (e.g., which may be connected with a container filled with the cleaning liquid), and may control a passage between the print head and the cleaning liquid. In turn, the controller may open the passage to effectuate cleaning. After entering the print head, the cleaning liquid may dissolve the dry ink in the print head and remove the blockage in the print head, which may clean the print head.

In step 806, a cleaning completion signal may be received.

The cleaning completion signal may indicate completion of a cleaning process of the print head. When a cleaning duration of the print head reaches preset cleaning duration, the cleaning completion signal may be received. Additionally and/or alternatively, the cleaning completion signal may be transmitted and/or received when the amount of the cleaning solution received by the print head may be greater than a preset value.

In step 808, in response to the cleaning completion signal, the moisturizing liquid may be received.

The moisturizing liquid may be configured to keep the print head moist, so as to prevent the ink from drying up and an orifice of the print head from being blocked. Corrosiveness of the moisturizing liquid may be less than corrosiveness of the cleaning liquid. The moisturizing liquid may be non-corrosive or less corrosive than the cleaning liquid.

After cleaning of the print head may be completed, the print head may receive the moisturizing liquid to be in the less corrosive moisturizing liquid. Additionally and/or alternatively, the moisturizing liquid may also moisturize the print head, prevent the ink from drying up, and/or may prevent the orifice of the print head from being blocked, which may be conducive to ensuring operation performance of the print head so that printing quality may be ensured when the print head may be used for printing next time. The print head may be kept in the moisturizing liquid for a long time, and the moisturizing liquid might be configured to (e.g., might be comprised of substances that) have little influence on the print head.

Many of the aspects described herein may solve two failure problems of corrosion and blockage of the print head easily caused in printing with the ink. The cleaning liquid may be poured into the print head to clean the print head after each time of printing, and then the moisturizing liquid may be poured into the print head and replace the cleaning liquid with strong corrosiveness, so that the print head may be cleaned and moisturized after each time of printing, the probability that the print head may be corroded may be reduced by increasing the frequency of cleaning, and/or there may be almost no ink in the print head when the printer may be not in operation. The concern of blockage of the print head may be reduced by the cleaning liquid and the moisturizing liquid, and the risk of corrasion of the print head may be reduced by the moisturizing liquid. Therefore, aspects described herein may ensure the operation performance of the print head, thus improving operation reliability of the printer.

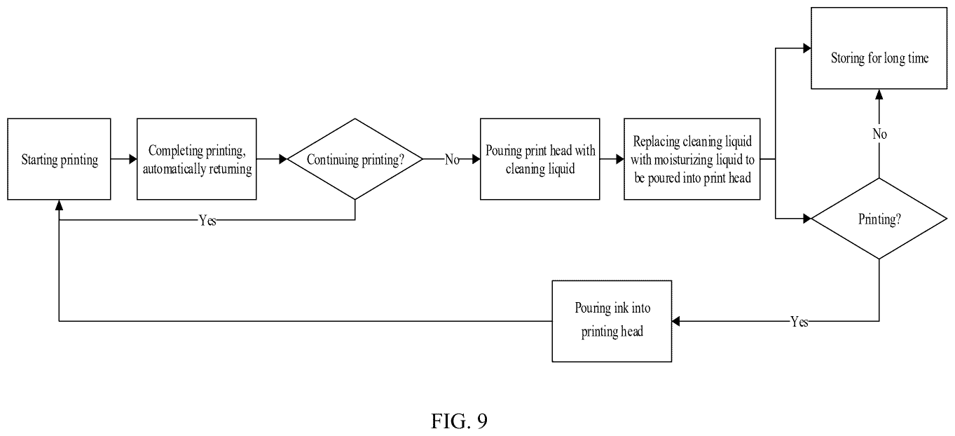

In order to better understand the above disclosure, detailed explanation is made below in combination with a specific example. Taking a piezoelectric print head and UV ink as an example, to solve two failure problems of the piezoelectric print head when printing the UV ink, a core solution strategy of this method may be to reduce residence time of the UV ink in the print head. As shown in FIG. 9, a core process may be that after each time of printing, the print head automatically returns to the ink cleaning position, and the print head may be poured with the cleaning liquid (to completely clean the print head), and the print head may be poured with the moisturizing liquid (to replace the corrosive cleaning liquid), and the ink may be poured into the print head again when printing again. Using this method, there may be no UV ink in the piezoelectric print head during a period in which the printer does not operates.

According to the different forms of ink supply path of the printer, the maintenance method of the print heads may be of two types.

1. Regarding the printer with the continuous ink supply path.

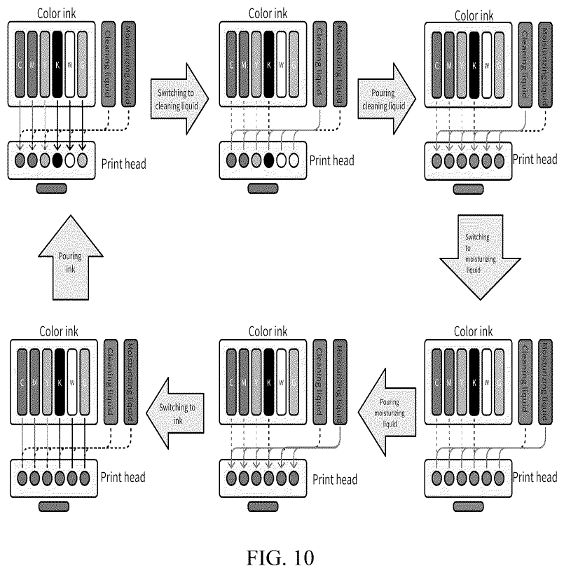

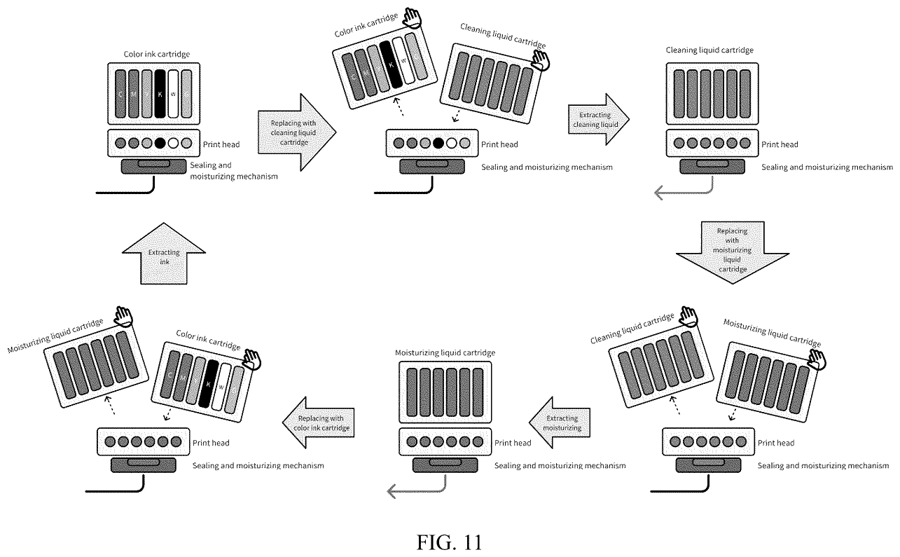

As shown in FIG. 10, the liquid inlet channel of the print head may be switched from the first liquid inlet channel for receiving the ink to the second liquid inlet channel for receiving the cleaning liquid by a solenoid valve (or other valves). A driving pump of the cleaning liquid may be adopted to inject the cleaning liquid into the print head in a form of pulses for many times until the ink may be substantially and/or completely discharged (e.g., because an internal volume of the print head may be at a microliter level, only 5 ml to 10 ml of the cleaning ink may be required). After the ink may be completely discharged, the valve may switch the liquid inlet channel of the print head to a moisturizing liquid channel (the third liquid inlet channel), and a driving pump of the moisturizing liquid may be adopted to inject the moisturizing liquid into the print head in a form of pulses for many times until the cleaning liquid may be completely discharged. At this time, automatic cleaning of the print head may be completed.

When the user needs to print, the valve may be adopted to switch the liquid inlet channel of the print head to the ink channel (the first liquid inlet channel), and the ink may be pumped out through the sealing and moisturizing mechanism until the print head may be filled up with the ink, and then a flash jetting process may be carried out once to ensure that there may be no color mixing of a trace amount of the ink in each channel (the amount of ink consumed in this process may be usually less than 5 ml), at which time automatic ink injection of the print head may be completed. C, M, Y, K, W and G shown in the drawings respectively indicate ink sub-cartridges for accommodating different colors in the ink cartridge, and different letters indicate different colors.

2. Regarding the printer with the direct-insertion ink path.

In this case, there may be three direct-insertion cartridges: an ink cartridge, a cleaning liquid cartridge, and a moisturizing liquid cartridge.

The ink cartridge may be a color ink cartridge. As shown in FIG. 11, the color ink cartridge may be installed on the print head for printing in a normal printing state. When the user needs maintenance, the color ink cartridge may be removed and replaced with the cleaning liquid cartridge. After the cleaning fluid cartridge may be detected to be in place, the print head may be filled up with the cleaning fluid through the sealing and moisturizing mechanism of the print head until the ink may be completely discharged, and a prompt may be sent to the user. At this time, the user might remove the cleaning liquid cartridge and replaces the cleaning liquid cartridge with the moisturizing liquid cartridge. After the moisturizing liquid cartridge may be detected to be in place, the print head may be filled up with the moisturizing liquid through the sealing and moisturizing mechanism of the print head until the cleaning liquid may be completely discharged, at which time automatic cleaning of the print head may be completed. C, M, Y, K, W and G shown in the drawings respectively indicate ink sub-cartridges for accommodating different colors in the ink cartridge, and different letters indicate different colors.

With the above maintenance method of the print head, the service life of the print head may be prolonged, the risk of blockage of the print head may be reduced, the print head channel may be kept opening, and printing quality each time may be guaranteed. In a scene where the print head does not print for a long time, there may be no need for regular flash jetting or use, and opening of the print head may also be ensured.

Although the various steps in the flowcharts involved in the examples described above are displayed in the order indicated by the arrows, these steps are not necessarily performed in the order indicated by the arrows. There may be no strict sequential restriction on the execution of these steps, and they may be performed in other orders. Furthermore, at least some of the steps in the flowcharts involved in the examples described above may include multiple steps or multiple stages, and these steps or stages need not be completed at the same time but may be executed at different times. The execution order of these steps or stages may be also not necessarily sequential but may alternate or interleave with at least part of other steps, or at least part of steps or stages in the other steps.

Based on the same inventive concept, a maintenance device of a print head for realizing the maintenance method of the print head is disclosure herein. A solution to the problem provided in this device may be similar to the solution recorded in the above method(s), and thus specific limitation of one or more examples of the maintenance device of the print head provided below may be found in the above limitation of the maintenance method of the print head, and will not be repeated herein.

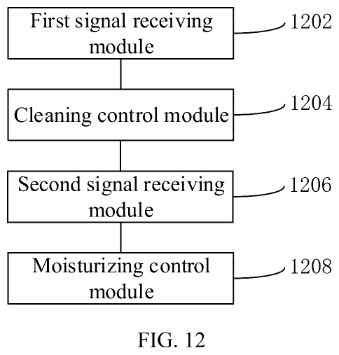

As shown in FIG. 12, a maintenance device of a print head may be provided, which may include a first signal receiving module 1202, a cleaning control module 1204, a second signal receiving module 1206, and/or a moisturizing control module 1208, in which: the first signal receiving module 1202 may be configured to receive a printing completion signal; the cleaning control module 1204 may be configured to control a cleaning liquid to be poured into the print head in response to the printing completion signal; the second signal receiving module 1206 may be configured to receive a cleaning completion signal; and/or the moisturizing control module 1208 may be configured to control a moisturizing liquid to be poured into the print head in response to the cleaning completion signal. In such a circumstance, the moisturizing liquid may be configured to keep the print head moist, a corrosiveness of the moisturizing liquid may be less than corrosiveness of the cleaning liquid, and/or the cleaning completion signal may be configured to indicate completion of a cleaning process of the print head.

The cleaning control module may be configured to control the cleaning liquid to enter the print head until the ink in the print head may be completely discharged.

The moisturizing control module may be configured to control the moisturizing liquid to enter the print head until the cleaning liquid in the print head may be completely discharged.

The maintenance device of a print head may include a printing control module configured to control the ink to be poured into the print head if a printing signal may be received after the moisturizing control module controls the moisturizing liquid to be poured into the print head.

The printing control module may be configured to, after controlling the ink to be poured into the print head if a printing signal may be received, control the print head to perform flash jetting after the print head may be filled up with the ink.

The maintenance device of a print head may include a returning control module configured to control the print head to return to an ink cleaning position after the signal receiving module receives a printing completion signal and before the cleaning control module controls a cleaning liquid to be poured into the print head.

The cleaning control module may be configured to control the cleaning liquid to be injected into the print head in a pulse manner.

The moisturizing control module may be configured to control the moisturizing liquid to be injected into the print head in a pulse manner.

The print head may be provided with a plurality of liquid inlet channels, and the liquid inlet channels of the print head include a first liquid inlet channel for receiving the ink, a second liquid inlet channel for receiving the cleaning liquid, and/or a third liquid inlet channel for receiving the moisturizing liquid. The cleaning control module may be configured to control the second liquid inlet channel to open so that the cleaning liquid enters the print head. The moisturizing control module may be configured to control the third liquid inlet channel to open so that the moisturizing liquid enters the print head.

The print head may be provided with two liquid inlet channels including a first liquid inlet channel for receiving the ink and a second liquid inlet channel for receiving the cleaning liquid or the moisturizing liquid. The cleaning control module may be configured to control the second liquid inlet channel to open so that the cleaning liquid enters the print head. The moisturizing control module may be configured to control the second liquid inlet channel to open so that the moisturizing liquid enters the print head.

The print head may be provided with one liquid inlet channel configured to receive the ink, the cleaning liquid, and/or the moisturizing liquid. The cleaning control module may be configured to control the liquid inlet channel to open so that the cleaning liquid enters the print head if it may be detected that the liquid inlet channel receives the cleaning liquid. The moisturizing control module may be configured to control the liquid inlet channel to open so that the moisturizing liquid enters the print head if it may be detected that the liquid inlet channel receives the moisturizing liquid.

All or part of the modules in the maintenance device of a print head may be implemented in software, hardware, and/or a combination of both. The above modules may be embedded in or independent of the processor of the computer device in a hardware form, and/or stored in the memory of the computer device in a software form, so that the processor can invoke and execute the operations corresponding to the above modules.

A service device of a print head for realizing the care method of the print head is further described herein. A solution to the problem provided in this device may be similar to the solution recorded in the above care method of the print head, and thus specific limitation of one or more examples of the service device of the print head provided below may be found in the above limitation of the care method of the print head, and will not be repeated herein.

There may be provided a care device of a print head, which may include a first signal acquisition module, a cleaning processing module, a second signal acquisition module, and/or a moisturizing processing module, in which: the first signal acquisition module may be configured to receive a printing completion signal; the cleaning processing module may be configured to receive a cleaning liquid in response to the printing completion signal, the cleaning liquid being configured to clean the print head; the second signal acquisition module may be configured to receive a printing completion signal; and/or the moisturizing processing module may be configured to receive a moisturizing liquid in response to the cleaning completion signal. The moisturizing liquid may be configured to keep the print head moist. A corrosiveness of the moisturizing liquid may be less than corrosiveness of the cleaning liquid. The cleaning completion signal may be configured to indicate completion of a cleaning process of the print head.

All or part of the modules in the care device of a print head may be implemented in software, hardware, and/or a combination of both. The above modules may be embedded in and/or independent of the processor of the computer device in a hardware form, and/or stored in the memory of the computer device in a software form, so that the processor can invoke and execute the operations corresponding to the above modules.

A printing apparatus may include a printer, a memory, and/or a processor. The printer may include a print head, the memory may store a computer program, and the processor may implement the steps of the above method examples when executing the computer program. The memory and the processor may be a memory and a processor of a controller provided inside the printer, and/or a memory and a processor of a terminal, and/or a server connected with the printer in communication. The processor of the printing apparatus may be configured to provide computing and control capabilities. The memory of the printing apparatus may include a nonvolatile storage medium and an internal memory. The nonvolatile storage medium may store an operating system, a computer program, and/or a database. The internal memory may provide an environment for execution of the operating system and the computer program in the nonvolatile storage medium. The computer program may implement a maintenance method of a print head when executed by the processor, the method comprising steps such as receiving a printing completion signal, then controlling a cleaning liquid to be poured into the print head to clean the print head, and/or, after the cleaning may be completed, controlling a moisturizing liquid to be poured into the print head to moisturize the print head.

A printer may be provided, which may include a print head. The print head may be configured to perform the care method of the print head. After a printing completion signal may be received, the print head may receive cleaning liquid for cleaning, and after a cleaning completion signal may be received, moisturizing liquid may be received for moisturizing.

A computer-readable storage medium having a computer program stored thereon may be provided. The computer program, when executed by a processor, may implement all or portions of the steps in the above method examples.

A computer program product may be provided including a computer program, which, when executed by a processor, may implement all or portions of the steps in the above method examples.

All or part of the processes in the above examples may be accomplished by instructing relevant hardware through a computer program. The computer program may be stored in a non-volatile computer-readable storage medium, and may include the processes of the examples of the above methods when executed. Any reference to memory, database, or other media used in the examples provided in the present disclosure may include at least one of non-volatile and volatile memories. The non-volatile memory may include a read-only memory (ROM), a magnetic tape, a floppy disk, a flash memory, an optical memory, a high-density embedded non-volatile memory, a resistive random-access memory (ReRAM), a magnetoresistive random access memory (MRAM), a ferroelectric random access memory (FRAM), a phase change memory (PCM), a graphene memory, and/or the like. The volatile memory may include a random-access memory (RAM), an external cache memory, and/or the like. The RAM may take various forms, such as a static random access memory (SRAM), a dynamic random access memory (DRAM), and/or the like. The databases involved in the examples provided in the present disclosure may include at least one of relational databases and non-relational databases. Non-relational databases may include distributed databases based on blockchain, but are not limited to these. The processors involved in the examples provided in the present disclosure may be general-purpose processors, central processing units, graphics processors, digital signal processors, programmable logic units, quantum computing based data processing logic units, artificial intelligence (AI) processors, and/or the like.

The technical features of the examples may be combined in any way. For conciseness of description, not all possible combinations of the technical features in the examples described above are described. However, these combinations should be within the scope of the description as long as no contradiction occurs in the combinations of these technical features.

The examples described above represent only several examples of the present disclosure. Countless variations and improvements may be made without departing from the spirit of the disclosure.

What may be claimed is:

1. A maintenance method of a print head, the method comprising:
receiving a printing completion signal;
in response to the printing completion signal, causing a cleaning liquid to be poured into the print head, wherein the cleaning liquid is configured to clean the print head;
receiving a cleaning completion signal that indicates completion of a cleaning process of the print head; and
in response to the cleaning completion signal, causing a moisturizing liquid to be poured into the print head, wherein:
the moisturizing liquid is configured to keep the print head moist, and
a corrosiveness of the moisturizing liquid is less than a corrosiveness of the cleaning liquid.

2. The maintenance method of claim 1, wherein the causing the cleaning liquid to be poured into the print head comprises:
causing the cleaning liquid to enter the print head until ink in the print head is completely discharged.

3. The maintenance method of claim 1, wherein the causing the moisturizing liquid to be poured into the print head comprises:
controlling the moisturizing liquid to enter the print head until the cleaning liquid in the print head is completely discharged.

4. The maintenance method of claim 1, further comprising:
causing, after receiving the printing completion signal and before causing the cleaning liquid to be poured into the print head, the print head to return to an ink cleaning position.

5. The maintenance method of claim 1, wherein the causing the cleaning liquid to be poured into the print head comprises:
causing the cleaning liquid to be injected into the print head in a pulse manner.

6. The maintenance method of claim 1, wherein the causing the moisturizing liquid to be poured into the print head comprises:
causing the moisturizing liquid to be injected into the print head in a pulse manner.

7. The maintenance method of claim 1, wherein the print head is provided with a plurality of liquid inlet channels comprising:
a first liquid inlet channel for receiving ink,
a second liquid inlet channel for receiving the cleaning liquid, and
a third liquid inlet channel for receiving the moisturizing liquid.

8. The maintenance method of claim 7,
wherein the causing the cleaning liquid to be poured into the print head comprises causing the second liquid inlet channel to open so that the cleaning liquid enters the print head, and
wherein the causing the moisturizing liquid to be poured into the print head comprises controlling the third liquid inlet channel to open so that the moisturizing liquid enters the print head.

9. The maintenance method of claim 1, wherein the print head is provided with two liquid inlet channels comprising:
a first liquid inlet channel for receiving ink, and
a second liquid inlet channel for receiving the cleaning liquid or the moisturizing liquid.

10. The maintenance method of claim 9,
wherein the causing the cleaning liquid to be poured into the print head comprises controlling the second liquid inlet channel to open so that the cleaning liquid enters the print head; and
wherein the causing the moisturizing liquid to be poured into the print head comprises causing the second liquid inlet channel to open so that the moisturizing liquid enters the print head.

11. The maintenance method of claim 1,
wherein the print head is provided with one liquid inlet channel configured to receive one or more of:
ink,
the cleaning liquid, or
the moisturizing liquid,
wherein the causing the cleaning liquid to be poured into the print head comprises causing the liquid inlet channel to open so that the cleaning liquid enters the print head if it is detected that the liquid inlet channel receives the cleaning liquid, and
wherein the causing the moisturizing liquid to be poured into the print head comprises causing the liquid inlet channel to open so that the moisturizing liquid enters the print head if it is detected that the liquid inlet channel receives the moisturizing liquid.

12. A care method of a print head, comprising:
receiving a printing completion signal;
in response to the printing completion signal, receiving a cleaning liquid configured to clean the print head;
receiving a cleaning completion signal that indicates a completion of a cleaning process of the print head; and
in response to the cleaning completion signal, receiving a moisturizing liquid configured to keep the print head moist, wherein a corrosiveness of the moisturizing liquid is less than a corrosiveness of the cleaning liquid.

13. The care method of claim 12, wherein the receiving the cleaning liquid comprises receiving the cleaning liquid until ink in the print head is completely discharged.

14. The maintenance method of claim 1, wherein the receiving the moisturizing liquid comprises receiving the moisturizing liquid until the cleaning liquid in the print head is completely discharged.

15. The care method of claim 12, further comprising:
causing, after receiving the printing completion signal and before receiving the cleaning liquid, the print head to return to an ink cleaning position.

16. The maintenance method of claim 1, wherein the receiving the cleaning liquid comprises receiving the cleaning liquid in a pulse manner.

17. The maintenance method of claim 1, wherein the receiving the moisturizing liquid comprises receiving the moisturizing liquid in a pulse manner.

18. A maintenance method of a print head, the method comprising:
receiving a printing completion signal; and
in response to the printing completion signal, causing a cleaning liquid to be poured into the print head, wherein the cleaning liquid is configured to clean the print head.

19. The maintenance method of claim 18, further comprising:
receiving a cleaning completion signal that indicates completion of a cleaning process of the print head; and
in response to the cleaning completion signal, causing a moisturizing liquid to be poured into the print head.

20. The maintenance method of claim 19, wherein the moisturizing liquid is configured to keep the print head moist, and wherein a corrosiveness of the moisturizing liquid is less than a corrosiveness of the cleaning liquid.
